(19) United States
(12) Patent Application Publication
(10) Pub. No.: US 2016/0021256 A1
(43) Pub. Date: Jan. 21, 2016

(54) ONLINE ADVERTISEMENT CAPABLE OF INITIATING A MISSED CALL

(71) Applicant: Facebook, Inc., Menlo Park, CA (US)

(72) Inventors: Kelly Leanne MacLean, Palo Alto, CA (US); Nikila Sarang Srinivasan, San Francisco, CA (US)

(21) Appl. No.: 14/335,801

(22) Filed: Jul. 18, 2014

(51) Int. Cl. H04M 7/00; G06Q 30/02

(52) U.S. Cl. CPC H04M 7/003; G06Q 30/0277

(57) ABSTRACT

A client device interacting with an online system displays an advertisement unit with an interface element that allows a viewing user to make a missed call. If the user selects the interface element, the client device makes a phone call to a third-party system that is configured to record an identifier for the client device without accepting the phone call. Because the phone call is not accepted, the user typically does not incur any phone charges for making the call. The third-party system then sends a response (such as a text message or a return phone call) to the client device with information related to the advertisement. As a result, the user can receive additional information about the advertisement without at no charge and without having to manually input the phone number for the third-party system.

### BACKGROUND

This disclosure relates generally to online systems, and in particular to presentation of advertisements to users of an online system.

“Missed calls” (known in some locales as “miskins,” “pitiful calls,” “flashing,” a “please call me,” or “beeping”) are a common practice in developing nations where users have limited financial resources and wish to communicate in a manner that does not cause them to incur phone charges. To make a missed call, a caller dials a phone number of another person, allows the line to ring for a predetermined number of times, and hangs up before the other person answers. The caller can vary the number of rings, the number of missed calls made, and the time the missed call is made to communicate different pieces of information to the other person. For example, in some places, two missed calls made in rapid succession before a previously-scheduled meeting are commonly understood to convey a message that the caller is running late. Because the other person does not accept the call, the caller usually does not incur any phone charges when making the missed call.

Typically, it is relatively easy for a user to make a missed call to a friend, family member, or business associate because the user is likely to have the other person's phone number saved in an address book application or speed dial feature on his or her phone. As a result, there is no need for the user to input the phone number manually when making the missed call.

Advertisers have also begun to use missed calls as a way to communicate with potential customers. For example, an advertiser displays a phone number on a billboard with an instruction for people to make a missed call to the phone number to receive more information. A system that receives the missed calls makes a return call to the callers and plays a recording with information about the product or service that was advertised. Because many telephone companies do not charge users for received calls, the information in the return call is communicated at no charge to the user. In contrast to making missed calls to friends, family, and business associates, a user is unlikely to have a phone number for an advertiser saved on his or her phone. Thus, when making a missed call to an advertiser, the user must manually input the advertiser's phone number. This can be a cumbersome process, especially if the user is accustomed to loading pre-saved phone numbers from an address book application or from a speed dial feature. As a result, users are less likely to make missed calls to an advertiser, which hinders the advertiser's ability to communicate with potential customers.

### SUMMARY

To improve the utility of missed calls to advertisers, an online system displays advertisement units that allow a user to make a missed call without requiring the user to input a phone number manually. For example, selecting an interface element (e.g., a missed call button) on an advertisement unit sends a phone number to a phone dialer module on the user's client device, and the phone dialer module dials the phone number. The ability to make the missed call without requiring the user to input the phone number streamlines the process for making a missed call and allows an advertiser to communicate with a larger audience.

In one embodiment, the online system receives an advertisement request from an advertiser. The advertisement request includes advertisement content, such as images or text, and a phone number associated with the advertiser. After the online system identifies an opportunity to provide the advertisement to a user, the online system sends instructions (e.g., in HTML or XML in a web page, or otherwise in an application running on the user's device) that the user's client device can execute to render and display an advertisement unit.

When displayed, the advertisement unit contains advertisement content and an interface element that allows the user to make a missed call. If the user selects the interface element, the client device is configured to initiate a phone call to the phone number. For example, as described above, the user's client device launches a phone dialer module on the client device to dial the phone number. The phone number connects the client device to a third-party system that is configured to record an identifier of the client device (e.g., a phone number associated with the client device) without accepting the call. Because the third-party system does not accept the phone call, the phone call has the same function as a missed call, and the user typically does not incur any charges for making the call.

After the missed call is made, the third-party system sends a response to the client device using the device identifier that was recorded. For example, the device identifier is a phone number associated with the client device and the third-party system sends a text message to the client device with further information related to the content of the advertisement, such as a list of stores where an advertised product can be purchased.

### BRIEF DESCRIPTION OF THE DRAWINGS

FIG. 1 is a block diagram of a system environment in which an online system operates, in accordance with one embodiment.

FIG. 2A is a block diagram of an online system, in accordance with one embodiment.

FIG. 2B is a block diagram of a client device, in accordance with one embodiment.

FIG. 2C is a block diagram of a client device, in accordance with another embodiment.

FIG. 3 is an interaction diagram illustrating a process for interacting with an advertisement to make a missed call, according to one embodiment.

FIG. 4 illustrates an example advertisement unit capable of making a missed call, in accordance with one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

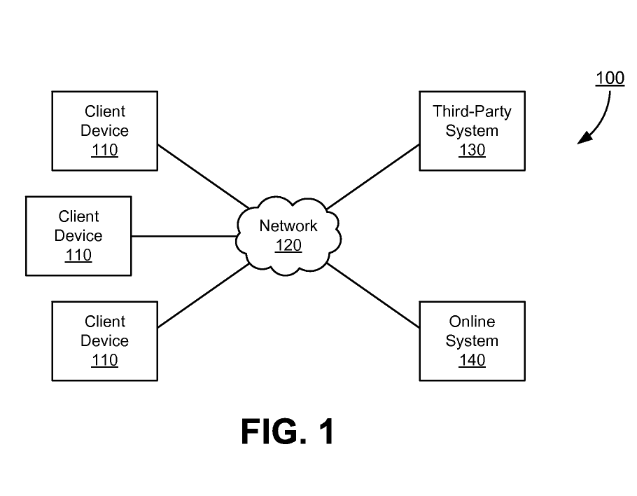

FIG. 1 is a block diagram of a system environment 100 for an online system 140. The system environment 100 shown in FIG. 1 comprises one or more client devices 110, a network 120, one or more third-party systems 130, and the online system 140. In alternative configurations, different and/or additional components may be included in the system environment 100.

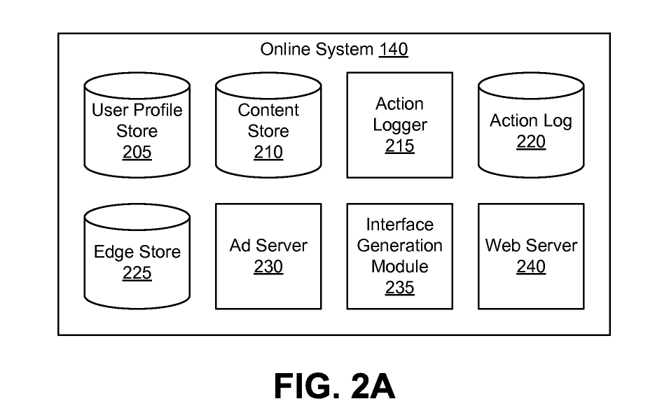

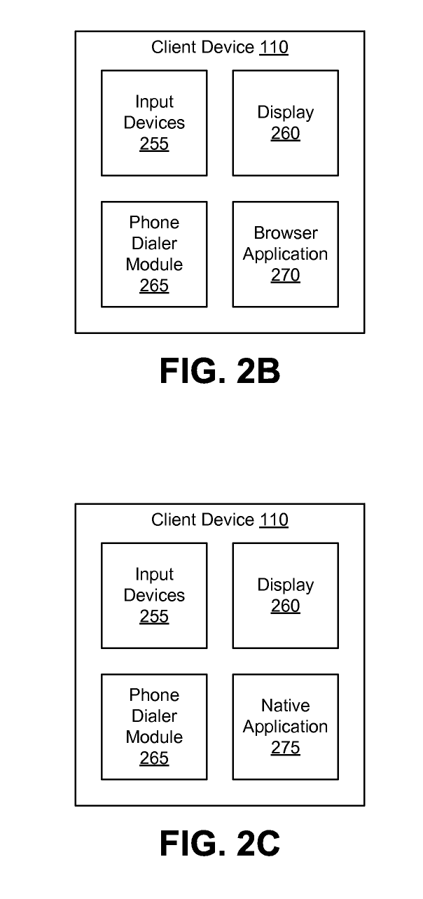

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. Embodiments of client devices 110 are further described below in conjunction with FIGS. 2B and 2C.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 2G, 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques. The network 120 may also include one or more technologies associated with making telephone calls, such as a telephone lines, fiber optic cables, microwave transmission, cellular networks, communications satellites, undersea telephone cables, and switching centers.

One or more third-party systems 130 may be coupled to the network 120 for communicating with the online system 140, which is further described below in conjunction with FIG. 2A. For example, the online system 140 is a social networking system and the third-party system 130 is a system operated by an advertiser that publishes advertisements on the social networking system. One or more of the third-party systems 130 may also receive missed calls, record phone numbers of client devices 110 that make missed calls to the system 130, and send responses to those client devices 110.

FIG. 2A is a block diagram of an architecture of the online system 140, which may be a social networking system in some embodiments. The online system 140 shown in FIG. 2A includes a user profile store 205, a content store 210, an action logger 215, an action log 220, an edge store 225, an ad server 230, an interface generation module, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party systems 130 or third-party applications separate from the online system 140. For example, a third-party system 130 operated by an advertiser may send objects containing advertisements to the online system 140. In one embodiment, objects in the content store 210 represent single pieces of content, or content “items.” Hence, social networking system users are encouraged to communicate with each other by posting text and content items of various types of media to the online system 140 through various communication channels. This increases the amount of interaction of users with each other and increases the frequency with which users interact within the online system 140.

One or more advertisement requests (“ad requests”) are included in the content store 210. An ad request includes advertisement content, a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an ad request may include one or more targeting criteria specified by the advertiser. Targeting criteria included in an ad request specify one or more characteristics of users eligible to be presented with advertisement content in the ad request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an ad request. As another example, targeting criteria identifies users having a connection to another user or object or having a particular type of connection to another user or object.

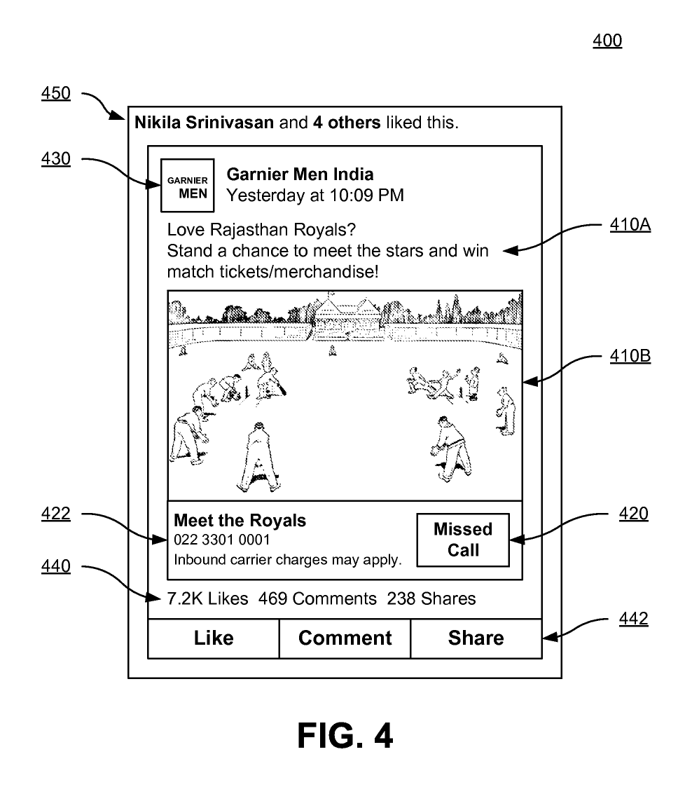

An ad request may also include one or more phone numbers. When a client device 110 dials one of the phone numbers, a telephonic connection is formed between a client device 110 and a third-party system 130. As described in further detail with reference to FIG. 4, the third-party system 130 that receives phone calls is configured to terminate the telephonic connection without accepting the phone call. Thus, the phone number is used to make a missed call, and a user whose client device 110 dials the phone number generally does not incur any phone charges.

Ad requests that include multiple phone numbers also include one or more selection rules that can be used to select one of the phone numbers to be displayed when the advertisement is presented to a user. For example, the rules may select a phone number based on the context in which the advertisement is presented (e.g., a first phone number is selected if the advertisement is presented in the user's newsfeed, and a second phone number is selected if the advertisement is presented in the user's profile page). The rules may also select a phone number based on other information, such as the targeting criteria that a user matched to trigger the presentation of the ad or information in the user's profile (e.g., the rules select different phone numbers users of different genders, age groups, or religions). In embodiments where the rules can select information based on the user's profile information or other information of a personal nature (e.g., the user's connections to other users or objects), the online system 140 may require the user to explicitly opt in to allowing his or her profile information to be used in this manner. Alternatively, the online system 140 may provide the user with an option to opt out of allowing his or her profile information to be used in this manner.

The action logger 215 receives communications about user actions internal to and/or external to the online system 140 and populates the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: adding comments to posts, sharing links, checking in to physical locations via a mobile device, accessing content items, and any other suitable interactions. Additional examples of interactions with objects on the online system 140 that are included in the action log 220 include: adding comments to a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions that are taken on a third party system 130 (e.g., an external website) and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, colleagues, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012,U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The advertisement server (“ad server”) 230 performs tasks associated with serving advertisements to users of the online system 140. For example, the ad server 230 identifies impression opportunities. An impression opportunity is any opportunity for a client device to display an advertisement to a user. For example, the ad server 230 detects an impression opportunity when the online system 140 receives a request from a client device 110 to present a new page of content to a user. The ad server 230 may also push advertisements to the user (i.e., the ad server 230 initiates the transfer of an advertisement to a client device 110 without receiving a request from the client device 110). After identifying an impression opportunity, the ad server 230 may select an ad request for display to the user. In one embodiment, the selection is based on the targeting criteria and the bid amounts for the ad requests.

In one embodiment, the ad server 230 also receives reports from third-party systems 130 that receive missed calls for a particular advertisement. The reports include data about the missed calls, such as the phone numbers of the client devices 110 making the missed calls and the time and date each missed call is received. The ad server 230 may perform statistical analysis on the data in the reports to measure the effectiveness of advertisements that were displayed. The ad server 230 may also use the phone numbers in the report to build a custom audience for subsequent impressions of the same advertisement or of other advertisements from the same advertiser. Advertisers can use custom audiences to retarget users of the online system 140 based on whether those users engaged with a missed call advertisement unit in the past. The process of building a custom audience is described in detail in U.S. patent application Ser. No. 14/034,350, filed on Sep. 23, 2013, which is incorporated by reference herein in its entirety.

The interface generation module 235 generates instructions that a component of a client device 110 can execute to display an advertisement unit (“ad unit”). For example, the interface generation module 235 generates content in a format such as HTML or XML that a browser application on a client device 110 (e.g., the browser application 270 shown in FIG. 2B) can use to render an ad unit. As another example, the interface generation module 235 sends content in a proprietary format that a native application on a client device 110 (e.g., the native application 275 shown in FIG. 2C) can use to render an ad unit.

The web server 240 links the online system 140 via the network 120 to the client devices 110 and the third party systems 130. The web server 240 serves web pages, as well as other web-related content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that is stored in the content store 210. Additionally, the web server 240 may provide application programming interface (API) functionality to send data directly to native client device operating systems, such as IOS®, ANDROID™, WEBOS®, or BlackberryOS.

FIG. 2B is a block diagram of one embodiment of an architecture of a client device 110. In the embodiment shown in FIG. 2B, the client device 110 includes input devices 255, a display 260, a phone dialer module 265, and a browser application 270. The client device 110 may also include additional components that are common to computing devices, such as a processor for executing computer program code, a non-transitory storage medium for storing program code and data (including program code and data for the browser application 270), and networking hardware interfacing with the network 120 to exchange data with the online system 140.

The input devices 255 are hardware devices configured to receive interactions from a user. Examples of an input device 255 include a numerical keypad, touch-sensitive surface (e.g., a touchscreen or trackpad), a mouse, or a keyboard. The display 260 is a hardware device that provides visual output to the user. For example, the display 260 may be a display device (e.g., a liquid crystal display (LCD) screen) integrated into the client device 110.

The phone dialer module 265 receives a phone number and initiates a telephonic connection between the client device 110 and the device associated with the phone number. In one embodiment, the module 265 comprises software that interacts with a hardware component of the client device 110 that is capable of connecting to a telephone network and making telephone calls. For example, the client device 110 is a cellular telephone with an antenna system and software for making phone calls. In another embodiment, the module 265 comprises software that connects via network hardware of the client device 110 to a separate device capable of connection to a telephone network and making telephone calls. For example, the client device 110 is a laptop or desktop computer connected to a cellular phone. In still another embodiment, the module 265 comprises software capable of making voice calls over the Internet. For example, the module 265 comprises Voice over Internet Protocol (VoIP) software.

The client device 110 executes the browser application 270 to exchange information between the client device 110 and the online system 140 via the network 120. The browser application 270 receives web pages or other content from remotely-connected web-servers (e.g., the web server 240 of the online system 140) and renders the web pages or other content for display to the user. For example, to interact with online system 140, the client device 110 executes the browser application 270 and communicates a command received from a user (e.g., a uniform resource locator (URL) for the online system 140 or selection of a link to the online system 140) to the online system 140.

FIG. 2C is a block diagram of one embodiment of an alternative architecture of a client device 110. Similar to the client device shown in FIG. 2B, the client device shown in FIG. 2C includes an input device 255 and a display 260. The client device 110 of FIG. 2C also includes native application 275 associated with the online system 140. The native application 275 runs on a native operating system of the client device 110 (e.g., IOS® or ANDROID™) Similar to the browser application 270 of the embodiment shown in FIG. 2B, the native application 275 communicates information between the client device 110 and the online system 140 in a manner that allows a user of the client device to interact with the online system.

Interacting with Online Advertisements to Make a Missed Call

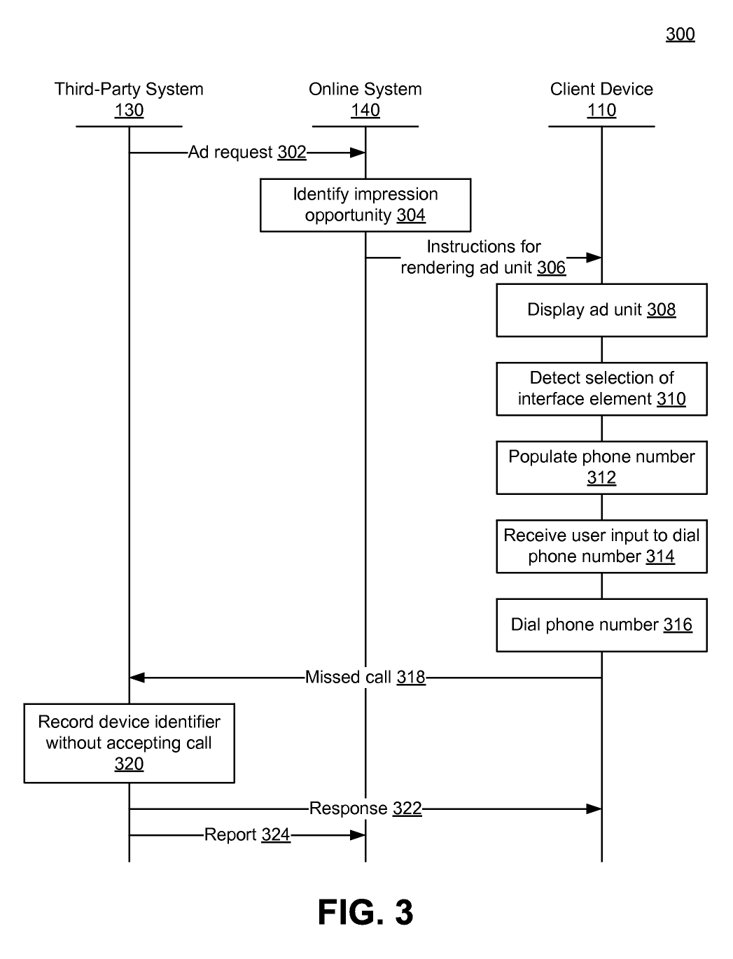

FIG. 3 is an interaction diagram of one embodiment of a method 300 for interacting with an advertisement to make a missed call. A third-party system 130 sends 302 an ad request to the online system 140. As described above with reference to FIG. 2A, the ad request includes advertisement content (e.g., text and images) and a phone number. The ad request may also include a bid amount, targeting criteria, additional phone numbers, and one or more selection rules. After receiving the ad request, the online system 140 stores the ad request as a content item in the content store 210. Users of the online system 140 can subsequently perform interactions with the ad request when it is displayed to users as an ad unit (e.g., in accordance with the process described below). The action logger 215 records these interactions and saves them in the action log 220.

After the ad server 230 of the online system 140 identifies 304 an impression opportunity on a client device 110, the interface generation module 235 generates instructions for rendering an ad unit corresponding to the ad request and sends 306 the instructions to the client device 110. The instructions include the portions of the ad request that are displayed to the user, such as the advertisement content and the phone number. The instructions may also include data from the action log 220 describing previous interactions with the ad request, such as interactions in which users expressed a preference for (“liked”) the ad, added a comment to the ad, or shared the ad.

The instructions can be generated and sent in any format that is compatible with an application on the client device 110 that is capable of displaying the ad unit. In one embodiment, the instructions are formatted in a markup language such as HTML or XML that the browser application 270 can render. Alternatively, the instructions are generated in a proprietary format that is compatible with the native application 275. For ease of description, the process that follows will be described with reference to an embodiment where a native application 275 performs tasks associated with the ad unit. However, the process can also be performed with a browser application 270 in place of a native application 275.

The native application 275 on the client device 110 executes the instructions to render and display 308 the ad unit to a user (the “viewing user”). In one embodiment, an ad unit includes advertisement content and a phone number (based on data in the corresponding ad request), an interface element, and other visual elements. An example ad unit 400 is shown in FIG. 4 and described in further detail below.

When an input device 255 on the client device 110 detects 310 a user selection of the interface element on the ad unit, the native application 275 sends the phone number to the phone dialer module 265 (e.g., via an API). In one embodiment, the phone dialer module 265 populates the phone number in a phone number field that is displayed to the user and prompts the user to provide another user input (e.g., by selecting a “call” button) before dialing the phone number. When the other user input is detected, the phone dialer module 265 initiates a telephonic connection between the client device 110 and the device associated with the phone number. In another embodiment, the phone dialer initiates the telephonic connection without waiting for another user input.

A third-party system 130 receives 318 the phone call from the client device 110. Upon receiving the phone call, the third-party system 130 records 320 a device identifier for the client device 110. The device identifier comprises an item of data that uniquely identifies the client device 110. For example, the client device 110 is a cellular phone and the device identifier is a phone number for the cellular phone. The third-party system 130 also terminates the phone call without accepting it. In one embodiment, the system 130 hangs up after the phone call rings for a predetermined number of times. Because the phone call is not accepted, the phone call is a missed call and typically does not cause the viewing user to incur any phone charges.

After receiving the missed call, the third-party system 130 sends 322 a response to the client device 110 using the device identifier that the system 130 recorded. In one embodiment, the device identifier is a phone number associated with the client device 110, and the third-party system 130 sends 322 the response by dialing the phone number and playing back the message when the viewing user accepts the phone call. The third-party system 300 may additionally or alternatively send a text message to the phone number.

The content of the response includes one or more items of information that the advertiser wishes to disseminate. For example, the response includes promotional information about a product or service that the advertiser is promoting, a coupon offering a discount on a product or service, one or more locations where an interested customer can examine and purchase a product, a branded message about a product, or information about a contest that consumers can enter. The third-party system 130 can vary the timing of the response (e.g., the response is a reminder for an event being promoted by the advertiser and the third-party system 130 sends the reminder one hour before the event is scheduled to begin) or send multiple responses over a period of time (e.g., the third-party system 300 sends reminders for multiple related events, such as a series of concerts). The response can also include a request that the user provide additional information (e.g., the response is an interactive phone call or a series of text messages that allows the user to fill out a survey or a lead generation form).

The third-party system 130 optionally sends 324 a report to the online system 140. The report contains a record of the missed calls that the third-party system 130 received during an interval of time. Each record of a missed call may include, for example, the date and time the missed call was received and the device identifier (e.g., a phone number) that was recorded. To protect the privacy of viewing users who made missed calls, the third-party system 130 may encrypt the device identifiers before adding them to the report. After receiving the report, the ad server 230 of the online system 140 can perform statistical analysis to determine the effectiveness of the ad request's impressions (e.g., by calculating the percentage of viewing users who made a missed call).

After receiving the report, the ad server 230 can optionally identify user profiles corresponding to the device identifiers. For example, the device identifiers are phone numbers, and the ad server 230 identifies user profiles that include the same phone numbers. After identifying the user profiles, the ad server 230 may record an indication that those users made a missed call to the phone number that was displayed in the ad unit. For example, the indication is stored in the profiles of the users to indicate that the users have expressed an interest in the advertisement content in the ad unit. In addition, the ad server 230 may send supplemental data about the identified users back to the third-party system 130. For example, the ad server 230 sends the gender associated with each device identifier back to a third-party system 130 operated by an advertiser, which provides the advertiser with data about the gender ratio of users who made the missed call. In some embodiments, the ad server 230 sends supplemental data about a user back to the third-party system 130 only if the user provides his or her consent. The ad server 230 may additionally or alternatively aggregate the supplemental data to increase the anonymity of the users. For example, instead of sending a gender associated with each device identifier, the ad server 230 sends an aggregated report indicating that 55% of the device identifiers belonged to male users and 45% of the device identifiers belonged to female users.

The ad server 230 can also perform one or more actions on behalf of a user associated with an identified user profile without receiving a direct input from the user to perform those actions. These actions are recorded by the action logger 215 and stored in the action log 220 in the same manner as actions based on inputs received directly from users. For example, after identifying the user profile of a viewing user who made a missed call using the ad unit, the ad server 230 automatically expresses a preference for (“likes”) the ad request or the user profile associated with the advertiser on behalf of the viewing user. The ad server 230 may also perform other actions on behalf of the viewing user, such as sending a message, adding a comment, or updating the viewing user's status with a text string generated by the online system 140 or the third-party system 130 (e.g., “I just made a missed call to the Rajasthan Royals!”). In some embodiments, the ad server 230 performs automatic actions in this manner only if the user associated with the user profile has explicitly provided his or her consent beforehand.

In addition, the ad server 230 can use the device identifiers in the report to build a custom audience using the device identifiers in the report and retarget the users in the custom audience with impressions of related advertisements. A process for building a custom audience in this manner is described with reference to U.S. patent application Ser. No. 14/034,350, filed on Sep. 23, 2013, which has been incorporated by reference herein in its entirety.

In an embodiment where the ad request includes multiple phone numbers and one or more selection rules, the ad server 230 runs the selection rules to select one of the phone numbers after identifying 304 an impression opportunity. The selection rules may select a phone number based on one or more selection criteria, such as the location of the ad unit (e.g., whether the ad unit is displayed in the viewing user's newsfeed or profile page, the targeting criteria that were trigged to display the ad unit, profile information of the viewing user (e.g., the viewing user's gender, age group, or religion), or connections of the viewing user (e.g., objects for which the viewing user has expressed a preference). As described above with reference to FIG. 2, the ad server 230 may require that the viewing user provide his or her permission before any of his or her personal information is used as input for the selection rules.

In this embodiment, some or all of the phone numbers are configured to initiate a telephonic connection to the same third-party system 130. Thus, in addition to recording 320 device identifiers, the third-party system 130 can also record the phone number that was dialed and use the phone number as a proxy for the selection criteria that were used to select the phone number. For example, if the selection rules cause the ad server 230 to provide male viewing users with a first phone number and female viewing users with a second number, the third-party system 130 records missed calls made to the first phone number as calls from male viewing users, while missed calls made to the second phone number are recorded as calls from female viewing users. To improve the anonymity of users, the third-party system 130 can also aggregate the missed call data and send a report 324 that contains the aggregated data but does not include records of individual missed calls. For example, the report indicates that 55% of callers for a particular advertisement were male while 45% were female but does not include information about the callers' device identifiers or the times at which the calls were made. As another example, the report indicates that 1000 callers for a particular advertisement were in the 25 to 34 age group while 850 callers were in the 35 to 49 age group.

In alternative embodiments, the client device 110 communicates with the third-party system 130 over a data connection (e.g., the Internet) instead of making a missed call. In this embodiment, steps 312 through 318 associated with making the missed call are not performed. Instead, when the client device 110 detects 310 a selection of the interface element, the client device 110 sends an indication that the user selected the interface element to the third party system 130 over the data connection. In one embodiment, the indication includes an identifier for the advertisement unit and a device identifier (e.g., an IP address) for the client device. Upon receiving the indication, the third-party system 130 records 320 the device identifier and uses the device identifier to send 322 a response to the client device 110. In another embodiment, the indication includes an identifier for the advertisement unit and an identifier for the user. In this embodiment, the third-party system 130 obtains the device identifier by querying the online system 140 using the user identifier. Upon receiving the query, the online system 140 sends the device identifier back to the third party system 130. The online system 140 may be configured to send the device identifier back to the third party system 130 only if the user has explicitly provided his or her consent beforehand.

In other alternative embodiments, the online system 140 obtains a device identifier for the client device 110 and sends the device identifier to the third-party system 130. In these embodiments, steps 312 through 320 are not performed. Instead, the client device 110 sends an indication that the user selected the interface element to the online system 140 after detecting 310 a selection the interface element. The indication may include an identifier for the advertisement unit and an identifier for the user of the client device 110. The online system 140 may then obtain the device identifier (e.g. the phone number associated with the client device 110) by accessing the user profile store 205 (e.g., using the identifier of the user). The online system 140 may also obtain the device identifier directly from the client device 110 (e.g., the client device 110 sends the device identifier along with the indication that that the user selected the advertisement unit). After obtaining the device identifier, the online system 140 sends the device identifier to the third-party system 130 and the third-party system 130 uses the device identifier to send 322 a response to the client device 110 in the manner described above. In one embodiment, the online system 140 only obtains and sends the device identifier to the third-party system 130 in this manner if the user explicitly provides his or her consent for the device identifier to be shared with an advertiser associated with the third-party system 130.

In still other alternative embodiments, the online system 140 acts as an advertising network that interacts with a third-party publishing system to display the ad unit to viewing users. In this embodiment, the online system sends 306 instructions for rendering the ad unit to a third-publishing system, and the third-party publishing system provides the ad to a viewing user. In these embodiments, the third-party publishing system may be configured to request an advertisement for a specific user of the online system 140 (e.g., by including a user identifier in the request that the online system 140 matches to an information item stored in a user's profile).

In the embodiment shown in FIG. 3, the same third-party system 130 sends 302 the ad request and performs tasks 318 through 324 associated with handling missed calls. In other embodiments, separate third-party systems send 302 the ad request and handle the missed calls. For example, a third-party system 130 operated by an advertiser sends 302 the ad request, but a third-party system 130 operated by a separate entity handles the missed calls. This arrangement is advantageous because it allows the advertiser to retain control over the process of creating and sending the ad request while another organization maintains systems necessary to perform the large-scale, automated tasks of receiving missed calls from a large number of client devices 110, recording 320 device identifiers, sending 322 responses, and generating and sending 324 reports. In this example, the systems handling the missed calls may also send a report to the third-party system 130 operated by the advertiser.

FIG. 4 is an example advertisement unit 400 capable of making a missed call. As illustrated, the example advertisement unit 400 including advertisement content 410A, 410B, an interface element 420, a phone number 422, a link to the advertiser's user profile 430, action information 440, action tools 442, and context information 450. Other advertisement units may be displayed with additional, fewer, or different components. For example, an advertisement unit may be displayed without context information 450.

The advertisement content 410A, 410B in the advertisement unit 400 is a visual representation of the advertisement content stored as part of the ad request corresponding to the advertisement unit 400. In the illustrated example, the advertisement content 410A, 410B includes text 410A and an image 410B. As described above, the advertisement content may also include a network address to which a user is directed when the advertisement is accessed. For example, when the viewing user selects the image 410B (e.g., by navigating to the image on a keypad, tapping the image on a touchscreen, or clicking the image with a mouse), the viewing user is directed to a network address associated with the Rajasthan Royals.

The interface element 420 is a visual element that, when selected, configures the client device 110 to initiate a phone call to the phone number in the ad unit. In some embodiments, the interface element 420 is a graphic that indicates to the viewing user that the element 420 is selectable. The element 420 may additionally or alternatively include text that indicates that the element 420 is selectable. For example, the interface element 420 is a graphical button accompanied by text that reads “missed call” (e.g., as shown in FIG. 4). In embodiments where the input devices 255 include a touch-sensitive surface, the interface element 420 may be a slide to select feature in which the user performs a sliding gesture on a visual element to make the selection.

The advertisement unit 400 optionally includes the visual display of phone number 422, as shown in FIG. 4. Although the viewing user does not have to manually input the phone number to make the missed call, including a visual display of phone number 422 may still have some advantages. For example, the viewing user can provide the phone number to other people or record the phone number with the intention of manually dialing it at a later time.

In embodiments where the advertisement unit 400 is rendered and displayed by a browser application 270 instead of a native application 275, the browser application 270 may be configured to adapt the visual display of the phone number 422 to have the function of the interface element 420. For example, the browser application 270 is configured to recognize text that is structured as a phone number and add special formatting to the phone number (e.g., changing the color and adding an underline) to indicate that the viewing user may select the phone number to make a call to the phone number. In these embodiments, the advertisement unit 400 might not include an interface element (e.g., a graphical button) separate from the phone number.

The advertisement unit 400 may also include a link 430 to a user profile associated with the advertiser. The linked user profile may include additional information related to the advertiser, such as information about products that the advertiser manufactures or sells or events that the advertiser is organizing. Thus, including a link 430 to the advertiser's user profile provides the user with a way of easily accessing this additional information after viewing the advertisement unit 400.

The action information 440 is data from the action log 220 that describes various interactions that the viewing user and other users of the online system 140 have performed with the advertisement unit 400. For example, the action information 440 includes the total number of times users have expressed a preference for (“liked”), added a comment to, or shared the advertisement unit 400 (as shown in FIG. 4). In some embodiments, the action information 440 includes information describing additional, fewer, or different types of interactions. In addition, the action information 440 may omit information describing interactions with the advertisement unit 400 even if those interactions have already occurred. For example, the total number of times that users have shared the advertisement unit 400 is not displayed as part of the action information 440 even if one or more users have already shared the advertisement unit 400.

The action tools 442 are visual elements that the viewing user can select to interact with the advertisement unit 400. In the example shown in FIG.4, the action tools 442 include tools to express a preference for (“like”) the advertisement unit 400, add a comment to the advertisement unit 400, and share the advertisement unit 400 with users who are connected to the viewing user. In other embodiments, the action tools 442 include additional, fewer, or different tools. For example, the tool to share the advertisement unit 400 may be omitted.

Context information 450 may also be displayed as part of the advertisement unit 400. Context information 450 includes any information that describes interactions that other users have performed with the advertisement unit 400. For example, context information 450 includes information that users connected to the viewing user have expressed a preference for the advertisement unit 400. Context information 450 may additionally or alternatively include an indication that many users of the online system 140 have interacted with the advertisement unit 400 or an object with similar content (e.g., an indication that the advertisement unit is a trending topic).

### CONCLUSION

The foregoing description of the embodiments have been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

What is claimed is:

1. A method comprising:
receiving, from an online system, instructions for rendering an advertisement unit, the advertisement unit comprising advertisement content and an interface element configured to initiate a process for making a phone call to a phone number responsive to a user selection of the interface element;
executing the instructions to display the advertisement unit on a client device;
detecting a user selection of the interface element; and
responsive to the user selection, configuring the client device to initiate a phone call to the phone number, wherein dialing the phone number causes the client device to create a telephonic connection to a third-party system that is configured to record an identifier of the client device without accepting the call.

2. The method of claim 1, wherein the third-party system is further configured to generate a report containing a record of a missed call from the client device.

3. The method of claim 1, wherein the advertisement unit further comprises an indication that at least one user connected to the user associated with the client device has expressed a preference for the advertisement content.

4. The method of claim 1, wherein the advertisement unit further comprises an indication that the advertisement content is a trending topic.

5. The method of claim 1, wherein the advertisement unit further comprises a link to a user profile associated with an advertiser promoting the advertisement content.

6. The method of claim 1, further comprising:
receiving a response from the third-party system, the response comprising information associated with the advertisement content.

7. The method of claim 6, wherein receiving a response comprises receiving a phone call comprising information associated with the advertisement content.

8. The method of claim 6, wherein receiving a response comprises receiving a text message comprising information associated with the advertisement content.

9. The method of claim 6, wherein the information associated with the advertisement content comprises a reminder for an event associated with the advertisement content.

10. The method of claim 1, wherein configuring the client device to initiate the phone call to the phone number comprises sending the phone number to a dialer application on the client device, the dialer application configured to dial the number responsive to a second user selection.

11. The method of claim 1, wherein configuring the client device to initiate the phone call to the phone number comprises configuring the client device to dial the phone number without waiting for a second user selection.

12. A non-transitory computer-readable storage medium having instructions encoded thereon that, when executed by the processor, cause the processor to:
receive an advertisement request from an advertiser, the advertisement request comprising advertisement content;
identify an impression opportunity to provide an advertisement unit containing the advertisement content to a viewing user;
provide instructions for rendering the advertisement unit to a client device of the viewing user, wherein the advertisement unit contains the advertisement content and an interface element that causes the client device to initiate a phone call to a predefined phone number, and wherein dialing the phone number causes the client device to create a telephonic connection to a third-party system that is configured to record an identifier of the client device without accepting the call; and
receive a report from the third-party system containing a record of a missed call from the client device of the viewing user.

13. The storage medium of claim 12, wherein the advertisement unit further comprises an indication that at least one user connected to the viewing user has expressed a preference for the advertisement content.

14. The storage medium of claim 12, wherein the advertisement unit further comprises an indication that the advertisement content is a trending topic.

15. The storage medium of claim 12, wherein the advertisement unit further comprises a link to a user profile associated with a business promoting the advertisement content.

16. The storage medium of claim 12, wherein the report further contains the identifier of the client device.

17. The storage medium of claim 16, further comprising instructions that cause the processor to:
identify a user profile associated with the viewing user, the user profile including the identifier of the client device contained in the report;
create an action indicating that the viewing user has expressed a preference for the advertisement content without receiving input from the viewing user indicating that the viewing user wishes to express a preference for the advertisement content; and
store the action.

18. The storage medium of claim 16, further comprising instructions that cause the processor to:
identify a user profile associated with the viewing user, the user profile including the identifier of the client device contained in the report;
generate a comment related to the advertising content;
create an action indicating that the viewing user has added the comment to the advertisement content without receiving input from the viewing user indicating that the viewing user wishes to add the comment; and
store the action and the comment.

19. A method comprising:
receiving an advertisement request from an advertiser;
identifying an impression opportunity to provide an advertisement unit associated with the advertiser to a viewing user; and
providing instructions for rendering the advertisement unit to a client device of the viewing user,
wherein the advertisement unit contains advertisement content and an interface element that causes the client device to initiate a phone call to a predefined phone number, and
wherein dialing the phone number causes the client device to create a telephonic connection to a third-party system that is configured to record an identifier of the client device without accepting the call.

20. The method of claim 19, wherein the advertisement unit further comprises an indication that at least one user connected to the viewing user has expressed a preference for the advertisement content.

21. The method of claim 19, wherein the advertisement unit further comprises an indication that the advertisement content is a trending topic.

22. The method of claim 19, wherein the advertisement unit further comprises a link to a user profile associated with a business promoting the advertisement content.

23. The method of claim 19, further comprising receiving a report from the third-party system containing a record of a missed call from the client device of the viewing user and the identifier of the client device.

24. The method of claim 23, further comprising:
identifying a user profile associated with the viewing user, the user profile including the identifier of the client device contained in the report;
creating an action indicating that the viewing user has expressed a preference for the advertisement content without receiving input from the viewing user indicating that the viewing user wishes to express a preference for the advertisement content; and
storing the action.

25. The method of claim 23, further comprising:
identifying a user profile associated with the viewing user, the user profile including the identifier of the client device contained in the report;
generating a comment related to the advertising content;
creating an action indicating that the viewing user has added the comment to the advertisement content without receiving input from the viewing user indicating that the viewing user wishes to add the comment; and
storing the action and the comment.
